(19) United States
(12) Patent Application Publication
(10) Pub. No.: US 2014/0267910 A1
(43) Pub. Date: Sep. 18, 2014

(54) METHOD OF MIRRORING CONTENT FROM A MOBILE DEVICE ONTO A FLAT PANEL TELEVISION, AND A FLAT PANEL TELEVISION

(71) Applicant: Samsung Electronics Co., Ltd., Suwon-si (KR)

(72) Inventors: Ridhi CHUGH, Noida (IN); Sachin SHARMA, Noida (IN); Amitoj SINGH, Noida (IN); Snehal DESHPANDE, Noida (IN)

(73) Assignee: Samsung Electronics Co., Ltd., Suwon-si (KR)

(21) Appl. No.: 14/209,242

(22) Filed: Mar. 13, 2014

(30) Foreign Application Priority Data
Mar. 13, 2013 (IN) 1059/CHE/2013
Nov. 27, 2013 (KR) 10-2013-0145563

(51) Int. Cl. H04N 5/44; H04N 5/64

(52) U.S. Cl. CPC H04N 5/44; H04N 5/64
USPC 348/552

(57) ABSTRACT

A flat panel television (TV) and a method of mirroring content from a mobile device onto the flat panel TV are provided. The method includes receiving one or more encoded audio-video packets from the mobile device that accesses the flat panel TV via a universal serial bus (USB) connection, decoding the one or more encoded audio-video packets and rendering the content, and displaying the content on the flat panel TV.

### CROSS REFERENCE TO RELATED APPLICATIONS

This application claims priority from Indian Patent Application No. 1059/CHE/2013, filed on Mar. 13, 2013, in the Indian Patent Office and Korean Patent Application No. 10-2013-0145563, filed on Nov. 27, 2013, in the Korean Intellectual Property Office, the disclosures of which are incorporated herein by reference, in their entireties.

### BACKGROUND

1. Technical Field

One or more exemplary embodiments relate to electronic devices. More particularly, one or more exemplary embodiments relate to a flat panel television (TV) and a method of mirroring content from a mobile device onto the flat panel TV by using universal serial bus (USB) access.

2. Description of the Related Art

At present, mobile devices (for example, smartphones and tablet personal computers (PCs)) may browse and view digital content such as music, videos, and photographs, via mobile Internet or Wi-Fi access. However, the mobile devices typically include a small-size screen compared to PCs. Therefore, a PC is often used to browse the Internet, share digital content with other people, and share and backup the digital content. Some TVs (for example, flat panel TVs) may be used for browsing. However, these TVs need landline access for Internet access, a docking station, or a TV output cable including an external adaptor. At present, in a smart TV including a Wi-Fi access cable, some of digital content may be shared through Wi-Fi access using a digital living network alliance (DLNA). However, the digital content cannot be shared without Wi-Fi access, or in a flat panel TV, the digital content cannot be shared without Wi-Fi hardware and a DLNA protocol.

Therefore, it is necessary to develop an efficient method and system that, by using USB access, mirrors digital content from a mobile device onto a flat panel TV, and provides synchronization and backup of the digital content.

### SUMMARY

One or more exemplary embodiments include a flat panel television (TV) and a method of minoring content from a mobile device onto the flat panel TV.

Additional aspects will be set forth in part in the description which follows and, in part, will be apparent from the description, or may be learned by practice of the exemplary embodiments.

According to one or more exemplary embodiments, a method of minoring content from a mobile device onto a flat panel TV includes: receiving one or more encoded audio-video packets from the mobile device that accesses the flat panel TV via a universal serial bus (USB) connection; decoding the one or more encoded audio-video packets, for rendering the content; and displaying the content on the flat panel TV.

According to one or more exemplary embodiments, a flat panel TV for mirroring content received from a mobile device includes: an interface configured to access a mobile device via a USB connection; a communication interface configured to perform electronic communication with the mobile device; a memory configured to store a plurality of instructions; and a processor configured to respond to the plurality of instructions, wherein, in response to the plurality of instructions, the processor is configured to receive one or more encoded audio-video packets from the mobile device that accesses the flat panel TV via the USB connection, decodes the one or more encoded audio-video packets for rendering the content, and displays the content on a screen of the flat panel TV.

An aspect of an exemplary embodiment may provide a television (TV) for minoring content received from a mobile device, the TV including: an interface configured to access a mobile device; a communication interface configured to perform electronic communication with the mobile device; a processor configured to respond to a plurality of instructions, wherein, in response to the plurality of instructions, the processor is configured to receive one or more encoded audio-video packets from the mobile device that accesses the TV, the processor is configured to decode the one or more encoded audio-video packets, and rendering the content, and the processor is configured to display the content on a screen of the TV, wherein the communication device may be configured to access the one or more audio-video packets via a universal serial bus (USB) connection.

The TV may be a flat panel TV, and the TV may further include a memory configured to store a plurality of instructions.

The processor may be configured to receive the one or more audio-video packets via the USB connection.

### BRIEF DESCRIPTION OF THE DRAWINGS

The accompanying figure, similar reference numerals may refer to identical or functionally similar elements. These reference numerals are used in the detailed description to illustrate various embodiments and to explain various aspects and advantages of the present disclosure.

FIG. 1 illustrates a block diagram of an environment, and various exemplary embodiments may be implemented depending on the environment.

FIG. 2 is a block diagram of a flat panel television (TV) according to an exemplary embodiment.

FIG. 3 exemplarily illustrates an operation of generating encoded audio-video packets, according to an exemplary embodiment.

FIG. 4 exemplarily illustrates an operation of decoding encoded audio-video packets, according to an exemplary embodiment.

FIG. 5 is a flowchart which illustrates a method of minoring content from a mobile device onto a flat panel TV by using universal serial bus (USB) access, according to an exemplary embodiment.

FIG. 6 exemplarily illustrates a flat panel TV according to an exemplary embodiment.

FIGS. 7A and 7B illustrate, in an exemplary manner, a mobile cradle included in a flat panel TV, according to an exemplary embodiment.

FIG. 8 illustrates, in an exemplary manner, a flat panel TV according to another exemplary embodiment.

### DETAILED DESCRIPTION OF THE EXEMPLARY EMBODIMENTS

Reference will now be made in detail to the exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description. Expressions such as “at least one of,” when preceding a list of elements, modify the entire list of elements and do not modify the individual elements of the list.

It should be understood that operations of the present method and elements of a system are illustrated in the drawings by using conventional signs, and only detailed matters relevant to understanding of the exemplary embodiments are illustrated. Also, a matter obvious to one of ordinary skill in the art may not be disclosed. In the exemplary embodiments, the terms “first,” “second,” etc. indicating a relationship may be used to distinguish one entity from another entity without unnecessarily implicating an actual relationship or order between entities.

Exemplary embodiments provide a flat panel television (TV) and a method of minoring content from a mobile device onto the flat panel TV by using universal serial bus (USB) access.

FIG. 1 illustrates a block diagram of an environment 100 for implementing various exemplary embodiments.

Referring to FIG. 1, the environment 100 includes a flat panel TV 105, a USB cable 110, a mobile device 115, and a network 120. The USB cable 110 connects the flat panel TV 105 and the mobile device 115 through a USB interface. The mobile device 115 is also connected to the network 120. Examples of the flat panel TV 105 may include a liquid crystal display (LCD) TV, a light-emitting display (LED) TV, a plasma TV, an organic light-emitting diode (OLED) TV, and a quantum dot display (QLED) TV, but are not limited thereto. Examples of the mobile device 115 may include a smartphone, a personal digital assistant (PDA), a tablet device, and a laptop personal computer (PC), but are not limited thereto. The mobile device 115 is a device that supports Internet access. Examples of the network 120 may include a local area network (LAN), a wide area network (WAN), and a wireless network, but are not limited thereto.

In an exemplary embodiment, a user may control the flat panel TV 105 by using a remote control device 130 (for example, a TV remote controller). In another exemplary embodiment, the user may control the flat panel TV 105 by using a remote mobile device 125. Examples of the remote mobile device 125 may include a block phone with Bluetooth® connection and a smartphone, but are not limited thereto. The remote mobile device 125 acting as a master device transmits a command to the mobile device 115 acting as a slave device. The remote mobile device 125 controls an operation of the mobile device 115 by using different communication protocols. Examples of the communication protocols may include a Bluetooth® protocol, an infrared (IR) protocol, and a wireless fidelity (Wi-Fi) protocol, but are not limited thereto.

In an example implementation, the remote mobile device 125 may include one or more of a touch pad and cursor control keys (for example, an up arrow key, a down arrow key, a left arrow key, a right arrow key, and an enter key), and are used to control the operation of the mobile device 115. Touch and cursor control events, which are respectively generated by using the touch pad and the cursor control keys in the remote mobile device 125, are captured by the mobile device 115, and are simultaneously displayed or typed on the flat panel TV 105.

The mobile device 115 accesses the flat panel TV 105 via a USB connection (for example, the USB cable 110). The mobile device 115 may be disposed on a mobile cradle included in the flat panel TV 105. The flat panel TV 105 receives one or more encoded audio-video packets from the mobile device 115. The flat panel TV 105 decodes the encoded audio-video packets to render digital content in the mobile device 115. Examples of the digital content may include music, video, and photographs which are accessed through the Internet, but are not limited thereto. Subsequently, the digital content is displayed to the user on the flat panel TV 105.

The flat panel TV 105 including a plurality of elements will be described in detail, with reference to FIG. 2.

FIG. 2 is a block diagram of the flat panel TV 105 according to an exemplary embodiment.

The flat panel TV 105 includes a bus 205 or another communication mechanism for communicating information and a processor 210 that is connected to the bus 205 to process the information. The flat panel TV 105 also includes a memory 215 (for example, a random access memory (RAM) or another dynamic storage device) connected to the bus 205, and the memory 215 stores instructions, which is to be executed by the processor 210, and information. The memory 215 may be used to store a temporary variable or other intermediate information while the processor 210 is executing the instructions. The flat panel TV 105 also includes a read-only memory (ROM) 220 or another static storage device, which is connected to the bus 205 and stores statistic information and instructions for the processor 210. A storage 225 (for example, a magnetic disk or an optical disk) is provided, and is connected to the bus 205 for storing information.

The flat panel TV 105 may be connected to a display 230 through the bus 205, for displaying digital content received from a mobile device (for example, the mobile device 115). An input device 235, which includes alphabetic numeric keys and other keys, is connected to the bus 205 for transferring a selection of information and a command to the processor 210. Another type of user input device is a cursor controller 240 (for example, a mouse, a trackball, or a cursor directional key) that transfers a selection of directional information and a command to the processor 210, and controls a movement of a cursor on the display 230. In some examples of implementation, a remote control device or a remote mobile device may be used as the user input device.

Various exemplary embodiments relate to the use of the flat panel TV 105, for implementing technology. The flat panel TV 105 performs the present technology in response to the processor 210 that executes instructions included in the memory 215. The instructions may be read from a machine-readable storage medium (for example, the storage 225) to the memory 215. The processor 210 performs a process stage described in the present specification by executing the instructions included in the memory 215.

In some exemplary embodiments, the processor 210 may include one or more processing units that perform one or more functions of the processor 210. The processing units are hardware circuits that replace software instructions or are used as a combination thereof, so as to perform arbitrary functions.

The term “a machine-readable storage medium” denotes all media that participate in providing data in order for a machine to perform an arbitrary function. In an embodiment that is implemented with the flat panel TV 105, for example, various machine-readable media may participate in providing instructions to the processor 210 for execution. The machine-readable medium may be a volatile or non-volatile storage medium. The non-volatile medium includes, for example, a dynamic memory such as the memory 215. The non-volatile medium includes, for example, an optical or magnetic disk such as the storage 225. All such mediums must be tangible in order for a physical mechanism, which reads the instructions into a machine, to detect the instructions of a corresponding medium.

General types of the machine-readable storage medium include, for example, a floppy disk, a flexible disk, a hard disk, a magnetic tape or other magnetic mediums, a CD-ROM, other optical mediums, punch cards, paper-tape, other physical media including a pattern of holes, RAM, programmable read-only memory (PROM), erasable programmable read-only memory (EPROM), flash-EPROM, and other memory chips or cartridges.

In another exemplary embodiment, the machine-readable medium may be a transmission medium that includes a coaxial cable, a copper wire, and an optical fiber or a transmission medium that includes the bus 205 and a wire. The transmission medium may have a type of optical wave or a sound wave, which is generated in response to radio-wave and infrared data communication being performed. Examples of the machine-readable medium may include a carrier wave or an arbitrary medium readable by the flat panel TV 105, but are not limited thereto. For example, instructions may be first stored in a magnetic disk of a remote computer. The remote computer may load the instructions to a dynamic memory thereof, and transmit the instructions by using a modem on a telephone wire. A local modem for the flat panel TV 105 may receive data via the telephone wire, and use an infrared transmitter for converting the data into an infrared signal. An infrared detector may receive the data carried in the infrared signal, and an appropriate circuit may supply the data to the bus 205. The bus 205 transfers the data to the memory 215, and the processor 210 searches for and executes the instructions stored in the memory 215. The instructions received from the memory 215 may be selectively stored in the storage 225 before or after the instructions is executed by the processor 210. All such mediums must be tangible in order for instructions of a corresponding medium to be detected by a physical medium which reads the instructions into a machine.

The flat panel TV 105 also includes a communication interface 245 connected to the bus 205. The communication interface 245 provides bidirectional data communication that connects the flat panel TV 105 and the mobile device 115. The mobile device 115 may also access the network 120. For example, the communication interface 245 may be an integrated services digital network (ISDN) card of a modem for providing data communication access to a corresponding type of telephone wire. As another example, the communication interface 245 may be a LAN card that provides data communication access to a compatible LAN. In such examples of implementation, the communication interface 245 transmits and receives an electrical signal, an electromagnetic signal, or an optical signal, and each of the signals carries a digital data stream indicating the various types of information.

In an exemplary embodiment, the mobile device 115 includes an element similar to that of the flat panel TV 105, and the element has a function similar to that of the flat panel TV 105.

The processor 210 of the flat panel TV 105 may operate to receive one or more encoded audio-video packets from the mobile device 115. The mobile device 115 accesses the flat panel TV 105 by using a USB connection (for example, the USB cable 110). The mobile device 115 may be disposed on the mobile cradle included in the flat panel TV 105. The processor 210 decodes the encoded audio-video packets to render digital content from the mobile device 115. Examples of the digital content may include music, videos, and photographs which are accessed via the Internet, but are not limited thereto. Also, the processor 210 may allow the digital content to be displayed to the user on the flat panel TV 105.

The processor 210 including a plurality of elements will be described in detail with reference to FIG. 4. The mobile device 115 including a plurality of elements will be described in detail with reference to FIG. 3.

FIG. 3 illustrates, in an exemplary manner, a partial configuration of the mobile device 115 that generates encoded audio-video packets, according to an exemplary embodiment.

The mobile device 115 includes an audio sink 305, a video sink 310, a multiplexer 315, an encoder module 320, and a USB interface 335, for generating encoded audio-video packets. The encoder module 320 includes a video encoder 325 and an audio encoder 330.

The audio sink 305 generates a plurality of audio packets, and the video sink 310 generates a plurality of video packets. The multiplexer 315 multiplexes and tags the audio packets and the video packets to provide one or more audio-video packets. Each of the audio-video packets is tagged with a time stamp. Subsequently, the audio-video packets are transmitted to the encoder module 320. The video encoder 325 encodes the video packets, and the audio encoder 330 encodes the audio packets. One or more encoded audio-video packets are generated, and are transmitted to the USB interface 335 of the mobile device 115 through the multiplexer 315.

One end of the USB cable (for example, the USB cable 115) is connected to the USB interface 335 of the mobile device 115.

FIG. 4 exemplarily illustrates a partial configuration of the flat panel TV 105 that decodes the encoded audio-video packets received from the mobile device 115, according to an exemplary embodiment.

The flat panel TV 105 includes a USB interface 405, a de-multiplexer 410, a decoder module 415, a renderer module 420, a display 230, and a speaker 445. The decoder module 415 further includes a video decoder 425 and an audio decoder 430. The renderer module 420 further includes a video renderer 435 and an audio renderer 440. The de-multiplexer 410, the decoder module 415, and the renderer module 420 may be included in the processor 210 of the flat panel TV 105.

The other end of the UBS cable (for example, the USB cable 115) is connected to the USB interface 405 of the flat panel TV 105.

The de-multiplexer 410 receives audio-video packets via the USB interface 405.

The de-multiplexer 410 de-multiplexes the audio-video packets, and transmits the de-multiplexed audio-video packets to the decoder module 415. The video decoder 425 decodes video packets, and the audio decoder 430 decodes audio packets. The video renderer 435 of the renderer module 420 renders the video packets, and the audio renderer 440 of the renderer module 420 renders the audio packets. The video renderer 435 renders the video packets to the display 230, and the audio renderer 440 renders the audio packets to the speaker 445.

FIG. 5 is a flowchart which illustrates a method of mirroring content from a mobile device (for example, the mobile device 115) onto a flat panel TV (for example, the flat panel TV 105) by using USB access, according to an embodiment of the present invention.

The mobile device is a device that supports Internet access. A user may view digital content in the mobile device by using the Internet access. Examples of the digital content may include music, videos, and photographs, but are not limited thereto.

First, the user connects the mobile device to the flat panel TV by using USB access. As an example, the USB access may include the use of the USB cable 110 that is connected between a USB interface of the mobile device and a USB interface of the flat panel TV.

In operation 510, the flat panel TV receives one or more encoded audio-video packets from the mobile device that accesses the flat panel TV by using the USB connection. In response to the mobile device accessing the flat panel TV, the flat panel TV receives the one or more encoded audio-video packets.

In operation 520, the flat panel TV decodes the received one or more encoded audio-video packets for rendering the digital content.

In operation 530, the digital content is displayed to the user on the flat panel TV. For example, via using the USB access, the user who views a video in a website by using the mobile device may view the video on the flat panel TV having a broader screen. Also, even in response to Internet facilities not being installed in the flat panel TV, by using a minoring function which is performed with the mobile device, the user may view a video as if the flat panel TV accesses the Internet.

In an exemplary embodiment, the user may control the digital content, which is displayed on the flat panel TV, by using a TV remote control device (for example, the remote control device 130).

In another exemplary embodiment, the user may control the digital content, which is displayed on the flat panel TV, by using a remote mobile device (for example, the remote mobile device 125). Examples of the remote mobile device 125 may include a block phone with Bluetooth® connection and a smartphone, but are not limited thereto. The remote mobile device 125 acting as a master device transmits a command to the mobile device 115 acting as a slave device. The remote mobile device 125 controls an operation of the mobile device 115 by using different communication protocols. Examples of the communication protocols may include a Bluetooth® protocol, an infrared (IR) protocol, and a Wi-Fi protocol, but are not limited thereto.

In an exemplary embodiment, the digital content may be stored in an internal memory (for example, the memory 215) of the flat panel TV.

In another exemplary embodiment, the digital content may be stored in an external hard disk drive.

In an exemplary embodiment, the digital content from the mobile device is synchronized with the internal memory of the flat panel TV for backup. That is, data (for example, content such as a photograph, music, and a telephone directory) stored in the mobile device may be stored in the internal memory of the flat panel TV, and thus, the content stored in the mobile device may be synchronized with the digital content stored in the internal memory of the flat panel TV. Therefore, a user's important information stored in the mobile device may be always stored in the stable memory of the flat panel TV.

In another exemplary embodiment, the digital content from the mobile device may be synchronized with an external hard disk drive connected to the flat panel TV, for backup. That is, data (for example, content such as a photograph, music, and a telephone directory) stored in the mobile device may be stored in the internal memory of the external hard disk drive, and thus, the content stored in the mobile device may be synchronized with the digital content stored in the external hard disk drive.

In an exemplary embodiment, a mobile device is disposed on a mobile cradle to thereby be recharged.

FIG. 6 exemplarily illustrates the flat panel TV 105 according to an exemplary embodiment. The USB cable 110 connects the flat panel TV 105 and the mobile device 115. As illustrated, the mobile device 115 is disposed on the mobile cradle included in the flat panel TV 105.

FIG. 7A illustrates the flat panel TV 105 according to an exemplary embodiment.

Referring to FIG. 7A, the flat panel TV 105 includes the USB interface 405, and also includes a mobile cradle 705 that is provided to support the mobile device 115. In FIG. 7A, in response to the mobile cradle 705 not being used, the mobile cradle 705 may be folded and accommodated in the flat panel TV 105.

FIG. 7B illustrates an example of using the mobile cradle 705 of FIG. 7A.

Referring to FIG. 7B, the mobile cradle 705 is taken out from the flat panel TV 105, and is unfolded, whereupon the mobile cradle 705 supports the mobile device 115 in order for the mobile device 115 to easily access the flat panel TV 105 by using the USB cable 110. The USB interface 335 of the mobile device 115 is illustrated. The mobile cradle 705 may be configured to support the mobile device 115, and moreover may be configured to charge the mobile device 115.

FIG. 8 illustrates, in an exemplary manner, the flat panel TV 105 according to another exemplary embodiment. Referring to FIG. 8, the remote mobile device 125 remotely accesses the flat panel TV 105 via the mobile device 115. The mobile device 115 also accesses the network 120. The USB cable 110 is connected between the flat panel TV 105 and the mobile device 115, and moreover, the mobile device 115 is disposed on the mobile cradle 705 included in the flat panel TV 105. The remote mobile device 125 controls digital content, which is displayed on the flat panel TV 105, by using different communication protocols via the mobile device 115. Examples of the communication protocols may include a Bluetooth® protocol, an infrared (IR) protocol, and a Wi-Fi protocol, but are not limited thereto.

According to the exemplary embodiments, digital content is mirrored from a mobile device (which is accessible to the Internet) onto a flat panel TV by using USB access. Therefore, a user may browse and view the digital content (for example, a website and application, a photograph, music, a movie, or a video) at high sound volume in a large-size screen, thereby sharing the digital content with many viewers. Examples of the website and application include a trip destination website, a train ticket issuing site, a marriage website, an email application, YouTube, TED talks, and a game application, but are not limited thereto. Also, the user may control the digital content by using a remote control device of the flat panel TV or a keypad of a remote mobile device. According to the exemplary embodiments, a user having economic fundamentals may purchase the flat panel TV for replacing a PC. Also, in the exemplary embodiments, a mobile cradle that supports the mobile device for USB access is provided in the flat panel TV.

The exemplary embodiments may also be implemented as computer-readable codes on a computer-readable recording medium. The computer-readable recording medium includes any data storage device that may store data which may be thereafter read by a computer system. Examples of the computer-readable recording medium include read-only memory (ROM), random-access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments of the present invention have been described with reference to the figures, it will be understood by those of ordinary skill in the art that various changes in form and details may be made therein without departing from the spirit and scope of the present invention as defined by the following claims.

What is claimed is:

1. A method of minoring content from a mobile device onto a television (TV), the method comprising:
receiving one or more encoded audio-video packets from the mobile device that accesses the TV;
decoding the one or more encoded audio-video packets, and rendering the content; and
displaying the content on the TV.

2. The method of claim 1, wherein the TV is a flat panel TV and wherein the mobile device is disposed on a mobile cradle included in the flat panel TV.

3. The method of claim 2, wherein the content displayed on the flat panel TV is controlled by a user using one of a remote control device and a remote mobile device.

4. The method of claim 3, wherein the content from the mobile device is stored in an internal memory of the flat panel TV.

5. The method of claim 2, wherein the content from the mobile device is synchronized with an internal memory of the flat panel TV.

6. A flat panel television (TV) for minoring content received from a mobile device, the flat panel TV comprising:
an interface configured to access a mobile device via a universal serial bus (USB) connection;
a communication interface configured to perform electronic communication with the mobile device;
a memory configured to store a plurality of instructions; and
a processor configured to respond to the plurality of instructions,
wherein, in response to the plurality of instructions,
the processor is configured to receive one or more encoded audio-video packets from the mobile device that accesses the flat panel TV via the USB connection,
the processor is configured to decode the one or more encoded audio-video packets, and rendering the content, and
the processor is configured to display the content on a screen of the flat panel TV.

7. The flat panel TV of claim 6, further comprising a mobile cradle that supports the mobile device.

8. The flat panel TV of claim 7, wherein the mobile cradle is further configured to charge the mobile device.

9. The flat panel TV of claim 6, wherein the content displayed on the screen of the flat panel TV is configured to be controlled by a user by using one of a remote control device and a remote mobile device.

10. The flat panel TV of claim 6, wherein the content received from the mobile device is configured to be stored in an internal memory of the flat panel TV.

11. The flat panel TV of claim 6, wherein the content received from the mobile device is configured to be synchronized with an internal memory of the flat panel TV.

12. A non-transitory computer-readable storage medium storing a program for executing the method of mirroring content from a mobile device onto a flat panel television (TV), the method comprising:
receiving one or more encoded audio-video packets from the mobile device that accesses the flat panel TV via a universal serial bus (USB) connection;
decoding the one or more encoded audio-video packets, for rendering the content; and
displaying the content on the flat panel TV.

13. The method of claim 1, wherein the TV is a flat panel TV.

14. A flat panel television (TV) for minoring content received from a mobile device, the flat panel TV comprising:
an interface configured to access a mobile device;
a communication interface configured to perform electronic communication with the mobile device; and
a processor configured to respond to a plurality of instructions,
wherein, in response to the plurality of instructions,
the processor is configured to receive one or more encoded audio-video packets from the mobile device that accesses the flat panel TV,
the processor is configured to decode the one or more encoded audio-video packets, and rendering the content, and
the processor is configured to display the content on a screen of the flat panel TV.

15. The flat panel TV of claim 14, further comprising a memory configured to store a plurality of instructions.

16. The flat screen TV of claim 14, wherein the interface is configured to access the mobile device via a universal serial bus (USB) connection and the processor is configured to receive the one or more audio-video packets via the USB connection.
